(19) United States
(12) Patent Application Publication
(10) Pub. No.: US 2019/0236507 A1
(43) Pub. Date: Aug. 1, 2019

(54) PROVIDING A MANUAL WORKSTATION

(71) Applicant: TRUMPF Werkzeugmaschinen GmbH + Co. KG, Ditzingen (DE)

(72) Inventors: Klaus Bauer, Ditzingen (DE); Eberhard Wahl, Weilheim an der Teck (DE)

(21) Appl. No.: 16/382,299

(22) Filed: Apr. 12, 2019

Related U.S. Application Data
(63) Continuation of application No. PCT/EP2017/075802, filed on Oct. 10, 2017.

(30) Foreign Application Priority Data
Oct. 13, 2016 (DE) 102016220015.1

(51) Int. Cl. G06Q 10/06; B25H 1/00

(52) U.S. Cl. CPC G06Q 10/06316; B25H 1/0092; G06Q 10/063114

(57) ABSTRACT

A manual workstation operating method includes: receiving, from a remote data-processing device, information relating to partial operating steps for producing a component at a manual workstation unit, the partial operation being established from order data by the remote data-processing device, displaying the information with respect to the partial operating steps by a user interface of the manual workstation unit, detecting component status data of the component by a sensor of the manual workstation unit, and transmitting at least one of the component status data and a production progress of the component based on the component status data to the remote data-processing device, such that the remote data-processing device can detect the production progress of the component and communicate completion of the component to a user or a data-processing system.

### CROSS REFERENCE TO RELATED APPLICATIONS

This application is a continuation of and claims priority under 35 U.S.C. § 120 from PCT Application No. PCT/EP2017/075802 filed on Oct. 10, 2017, which claims priority from German Application No. 10 2016 220 015.1, filed on Oct. 13, 2016. The entire contents of each of these priority applications are incorporated herein by reference.

### TECHNICAL FIELD

The invention relates to a manual workstation unit, remote data-processing device, manual workstation operating system, manual workstation operating method and method for providing a manual workstation and relates in particular to such devices and methods for minimizing the complexity with remote data-processing devices.

### BACKGROUND

In modern production environments, the incorporation of machines and networked production installations in operating processes is well-integrated and results in considerable productivity, efficiency and time savings. In modern production environments, however, there are still manual workstations. Manual workstations are production installations with a small degree of automation and a high proportion of manual work. They substantially comprise a workbench/work surface and a collection of tools which are often manually operated free hand by an operator in accordance with instructions. As a result of the low level of automation, there are malfunctions and additional expenditure in the process sequence since in this instance, in addition to the actual production of a workpiece, additional secondary activities arise, such as the manual production of operating instructions, printing and acquisition of explanations, instructions and drawings, a high degree of production complexity and high level of rejects as a result of inadequate or excessively complex instruction documents, lack of feedback relating to the progress of the operating step and generally lacking status monitoring and diagnosis of tools and machines.

### SUMMARY

One aspect of the invention features a manual workstation unit of a production installation of a production installation operator which has: a manual workstation for carrying out production operations on a component, which are carried out at least partially, in particular to a significant extent, manually, a manual workstation data-processing device having: a status data output interface which is configured to transmit via a status data input interface of a remote data-processing device information relating to the status of the manual workstation to the remote data-processing device, a control data input interface which is configured to obtain via a control data output interface of the remote data-processing device production information from the remote data-processing device, a manual workstation data-processing device data store for storing at least one production installation program, a user interface which is configured to output data from the manual workstation data-processing device to a user or to enable data inputs of the user to the manual workstation data-processing device, wherein the manual workstation unit further has at least one sensor which is suitable for detecting the component and transmitting component status data to the manual workstation data-processing device, wherein the at least one production installation program is configured to control the manual workstation data-processing device so as to transmit information relating to partial operating steps via the user interface to the user, and to transmit the component status data via the status data output interface to the status data input interface of the remote data-processing device in such a manner that the remote data-processing device can detect the production progress of the component. The production installation program is accordingly thus configured to control the manual workstation data-processing device in such a manner that
information relating to the status of the manual workstation can be transmitted to the remote data-processing device,
production information can be obtained from the remote data-processing device,
data can be output from the manual workstation data-processing device to a user or data of the user can be input into the manual workstation data-processing device.

At the manual workstation, a tool, in particular an electric tool, such as, for example, a grinding device, welding device, drill, thread cutter or similar devices which are operated by hand, may be provided. This tool may be monitored in terms of at least one operating parameter, such as the operating time thereof, the load thereof, the ambient temperature thereof and other parameters. The sensor(s) can be used to do this. A sensor may be the current measurement of the current consumed by the device. The tool may, however, also transmit data relating to the status thereof via a sensor which is arranged therein and a data interface to the manual workstation data-processing device. An example would be a radio connection, such as, for example, a Bluetooth connection. In this instance, at least one production installation program may further be configured to control the manual workstation data-processing device so as to transmit the operating parameter to the remote data-processing device.

It is further disclosed that the production installation program is configured to transmit inputs of the user to the manual workstation data-processing device or via the status data output interface and the status data input interface of the remote data-processing device to the remote data-processing device. This enables a monitoring of the manual workstation or the manual workstation unit via the company-internal status monitoring or diagnosis system. Feedback can thus be received and forwarded internally within the company or across the company. In particular, tool information relating to the manual workstation or the manual workstation unit and the remote data-processing device can also be transmitted to a tool manufacturer in order to provide them with information relating to the use of the tool, maintenance or further development.

It is further disclosed that with the manual workstation unit the at least one production installation program is configured to control the manual workstation data-processing device so that the manual workstation data-processing device establishes from the component status data a production progress and transmits the result to the remote data-processing device or that the manual workstation data-processing device transmits the component status data detected by the at least one sensor to the remote data-processing device so that the remote data-processing device can establish the production progress from the component status data. This enables automatic monitoring of the production progress.

It is further disclosed that the production installation program can be constructed in a modular manner, in particular from a plurality of production installation program modules. In this instance, for one or more operating process(es) a process production installation program module can be produced or replaced independently of other process production installation program modules.

The manual workstation data-processing device may further be configured in such a manner that data, in particular production installation program modules, can be produced, maintained or replaced individually for different tools, operating steps or components, in particular from third party providers, such as tool manufacturers, material suppliers, service providers and clients.

A tool provider is a company or a person which provides a tool 33 which is used at the manual workstation or which is responsible for the maintenance of the operability thereof.

A client may be a company a person which has requested implementation of production operations at the production installation.

A service provider may be a provider of services, such as software, measurement data detection, analysis systems, diagnostic tools or the like.

Consequently, operating instructions or process modifications during the production operations at the manual workstation can be rapidly taken care of by the third party provider(s). Interruption times in the production operations can thus be reduced.

The manual workstation data-processing device may further be configured in such a manner that data, in particular data from the tools used, can be provided via the remote data-processing device to third party providers, in particular tool manufacturers, material suppliers, service providers and clients. In this instance, data from the production installation can be classified in accordance with different confidentiality levels. A high confidentiality level may be transmitting data only anonymously. A low confidentiality level may be permitting data to be transmitted with an indication of origin but only to specific third party providers predetermined by the production installation operator.

A second aspect of the invention features a remote data-processing device which has: an order data input interface which is configured to receive customer orders for producing a component on a manual workstation unit as described above, a status data input interface which is configured to receive via the status data output interface of the manual workstation unit information relating to the status of the manual workstation, a control data output interface which is configured to transmit, via the control data input interface of the manual workstation unit, production information to the manual workstation unit, a remote data store for storing at least one production control program, wherein the at least one production control program is configured to control the remote data-processing device so as to establish, from an order input via the order data input interface, partial operating steps for producing a component, to transmit information relating to the partial operating steps via the control data output interface and the control data input interface of the manual workstation unit to the manual workstation unit, to receive component status data relating to the status data output interface of the manual workstation unit and the status data input interface in such a manner that the remote data-processing device can detect the production progress of the component.

It is further disclosed that the remote data-processing device further has: a tool database for storing information relating to tools which can be used on the manual workstation of the manual workstation unit. As a result of the fact that at the remote data-processing device information relating to the tools available at the manual workstation is recorded, the system can decide which modules of the production control program are required for this manual workstation unit and which production installation program module would have to be transmitted to the manual workstation unit in order to produce a component.

It is further disclosed that the remote data-processing device further has: an operating step database (production step database) for storing information relating to operating steps (production steps) which can be carried out at the manual workstation of the manual workstation unit. As a result of the fact that at the remote data-processing device information relating to the operating steps which can be carried out at the manual workstation is recorded, the system can decide which modules of the production control program are required for this manual workstation unit and which production installation program module would have to be transmitted to the manual workstation unit in order to produce a component.

It is further disclosed that the production control program is constructed in a modular manner, in particular from a plurality of production control program modules, so that for each operating process a process production control program module can be produced or replaced independently of other process production control program modules. This enables the isolated development of program modules, in particular by third party providers such as tool manufacturers and clients.

A third aspect of the invention features a manual workstation operating system which contains the above-described manual workstation unit and the above-described remote data-processing device. Production installation program modules and production control program modules can be produced individually for different tools, operating steps of components, in particular by third party providers such as tool manufacturers and clients.

It is further disclosed that the remote data-processing device has at least one additional interface for an additional production installation which is separated from the first production installation in terms of location or organization. The organizational separation is intended to be understood to mean that the additional production installation does not exchange any data with the first production installation. In particular, the production control program is intended to be configured in such a manner that it can be ensured that there is no provision of data of the first production installation with the additional production installation and vice versa.

It is further disclosed that the remote data-processing device has one, in particular a plurality of, tool provider interface(s) for one, in particular a plurality of, data connection(s) from the remote data-processing device to one, in particular a plurality of, in particular remote tool provider(s). This/these tool provider(s) may provide information for operating the tool via the remote data-processing device to the production installation operator(s). The production installation operator(s) may provide the tool provider(s) with data relating to the wear and the status of the tool used on the manual workstation. From this, information can be used for the improved tool wear, maintenance thereof or further development.

It is further disclosed that one, in particular a plurality, of the process production control program modules can be provided and/or replaced and/or maintained by one, in particular a plurality of, tool provider(s).

It is further disclosed that one, in particular a plurality, of the process production control program module(s) can be selected and used by one, in particular a plurality of, production installation operator(s).

The remote data-processing device may further have one, in particular a plurality of, order data input interface(s) for one, in particular a plurality of, data connection(s) from the remote data-processing device to one, in particular a plurality of, in particular remote client(s). The clients may in particular be located separately from each other in terms of location or organization.

The remote data-processing device may further have one, in particular a plurality of, service-provider interface(s) for one, in particular a plurality of, data connection(s) from the remote data-processing device to one, in particular a plurality of, in particular remote service provider(s). Service providers may in particular be located separately from each other in terms of location or organization.

The production control program may be configured to control the remote data-processing device in such a manner that the data of the clients, the tool producers, the production installation(s) and the service providers (together third party providers) in accordance with the provisions for providing of the data producers are separated from each other to such an extent that the individual third party providers only gain access to data which have been released to them by the data producer.

Anonymous data from the manual workstation unit or from a tool which is used at that location may, for example, also be of great significance for a tool manufacturer if it can, for example, draw conclusions relating to the conventional operating times. As a result, an operator of the remote data-processing device may expand the transmission of these data to a fee-based provision of a service.

A fourth aspect of the invention features a manual workstation operating method which has the steps of: receiving order data through a remote data-processing device, establishing partial operating steps for producing a component from the order data using the remote data-processing device, transmitting information relating to the partial operating steps to a manual workstation unit, displaying the information with respect to the partial operating steps by means of a user interface of the manual workstation unit, detecting component status data by means of a sensor of the manual workstation unit, transmitting component status data or a production progress of the component to the remote data-processing device, detecting the production progress of the component using the remote data-processing device, communicating the completion of the component using the remote data-processing device to a user or a data-processing system.

A fifth aspect of the invention features a method performed by a remote data-processing device to a manual workstation unit. The method has the steps: a) receiving order data by means of the remote data-processing device, b) determining sub-steps for producing a component from the order data by means of the remote data-processing device, c) transmitting information relating to the sub-steps to the manual work station unit, d) displaying the information relating to the sub-steps by means of a user interface of the manual work station unit, e) capturing component state data by means of a sensor of the manual work station unit, f) transmitting component state data or production progress of the component to the remote data-processing device, g) capturing the production progress of the component by means of the remote data-processing device, h) communicating completion of the component by means of the remote data-processing device to a user or to a data-processing system.

A sixth aspect of the invention features a method for providing a manual workstation which has the steps of: providing a remote data-processing device as described above, providing a manual workstation unit as described above, producing at least one operating-process-specific production control program module, storing the operating-process-specific production control program module in the remote data store, producing at least one operating-process-specific production installation program module, storing the operating-process-specific production installation program module in the manual workstation data-processing device data store. In this instance, the sequence of the method steps is purely exemplary. The individual steps may also be carried out in a different sequence.

The advantage of the device, system and method is that an operating instruction can be generated in the remote data-processing device. The tool manufacturer and the production installation operator may thus be granted access thereto separately.

It is further advantageous that none of the at least two persons authorized to access the remote data-processing device can obtain access to safety-relevant data of the other and at the same time can exchange data which are relevant for the order processing, tool wear, operating instructions.

Other advantages and advantageous embodiments of the subject-matter of the invention can be derived from the description, the drawings and the claims. The features and advantages which are mentioned above and those which are set out below may also be used individually or separately or in any combinations.

### DESCRIPTION OF DRAWINGS

An embodiment of the invention is described below with reference to the Figures, in which:

FIG. 1 shows an embodiment of a manual workstation operating system,

FIG. 2 shows a manual workstation unit of the embodiment,

FIG. 3 shows a remote data-processing device of the embodiment,

FIG. 4 shows a flow chart of a manual workstation operating method.

### DETAILED DESCRIPTION

Tests were carried out with intelligently networked assembly locations which by means of displays and projection systems reduce the process disruption. In such an intelligent networked assembly location, the system identifies the respective workpiece using sensor technology and loads a corresponding operating plan via a connection from the superordinate business application planning system. In order to teach the operator in particular also during the productive work for the operating step, the system can display the relevant production steps of the assembly process by means of an imaging method and monitor it by means of a camera system. Assembly steps can thereby be verified, the progress of the operating step can be controlled by means of gesture recognition and finally the correct assembly can be ensured. To this end, for example, an infrared dot pattern is projected into the room. The reflected infrared beams are received by means of an infrared camera system and combined using a triangulation method to form a depth image of the scene. In this manner, the entire assembly region can be identified and production steps can be monitored. Via a display system, visual aids in the form of text, graphics or video sequences can be provided or projected by means of a projection system directly onto the assembly workstation. For quality assurance, other interfaces for position recognition of screw data recognition may be provided, whereby tool processes (for example, position of a screwdriver system) can be identified and controlled in a selective manner.

With these intelligent networked assembly locations, the problem arises that, as a result of the high level of diversity of manual workstations, administration of such systems and a supply of such systems with corresponding information are difficult. Such stations are provided with different tools from different manufacturers. Furthermore, as a result of the large range of components which are intended to be produced, high demands are placed on the information systems. It is further problematic that the production of the operating instruction is complex since this generally has to be produced using learning methods.

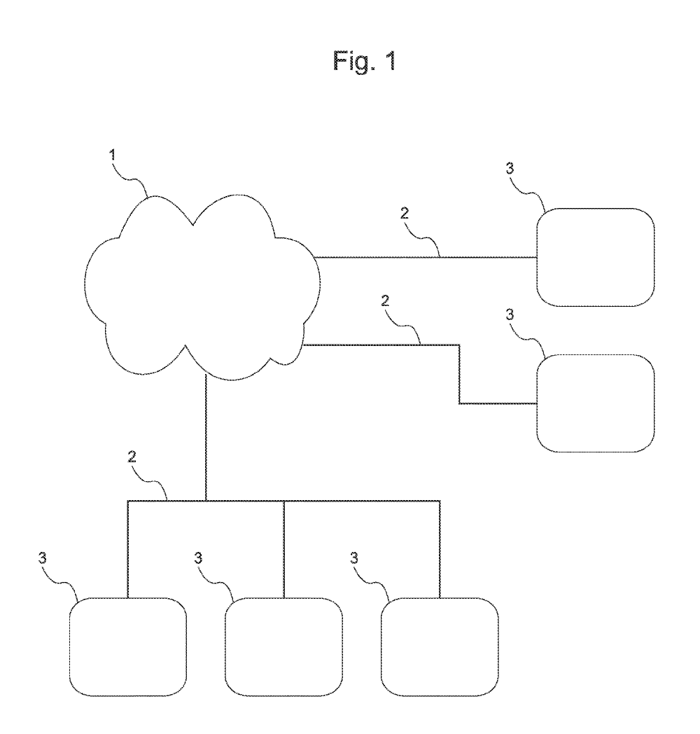

With reference to FIG. 1, an embodiment of a manual workstation operating system according to the invention will be described.

The manual workstation operating system has a remote data-processing device 1. The remote data-processing device is an electronic data-processing device which is accommodated locally remotely from a business premises. In this instance, it may be an individual electronic data-processing device (server) or an assembly of a plurality of data-processing devices (server cluster/cloud). The remote data-processing device 1 is connected by means of communication connections 2 to manual workstation units 3. It may also be connected to only one manual workstation unit 3.

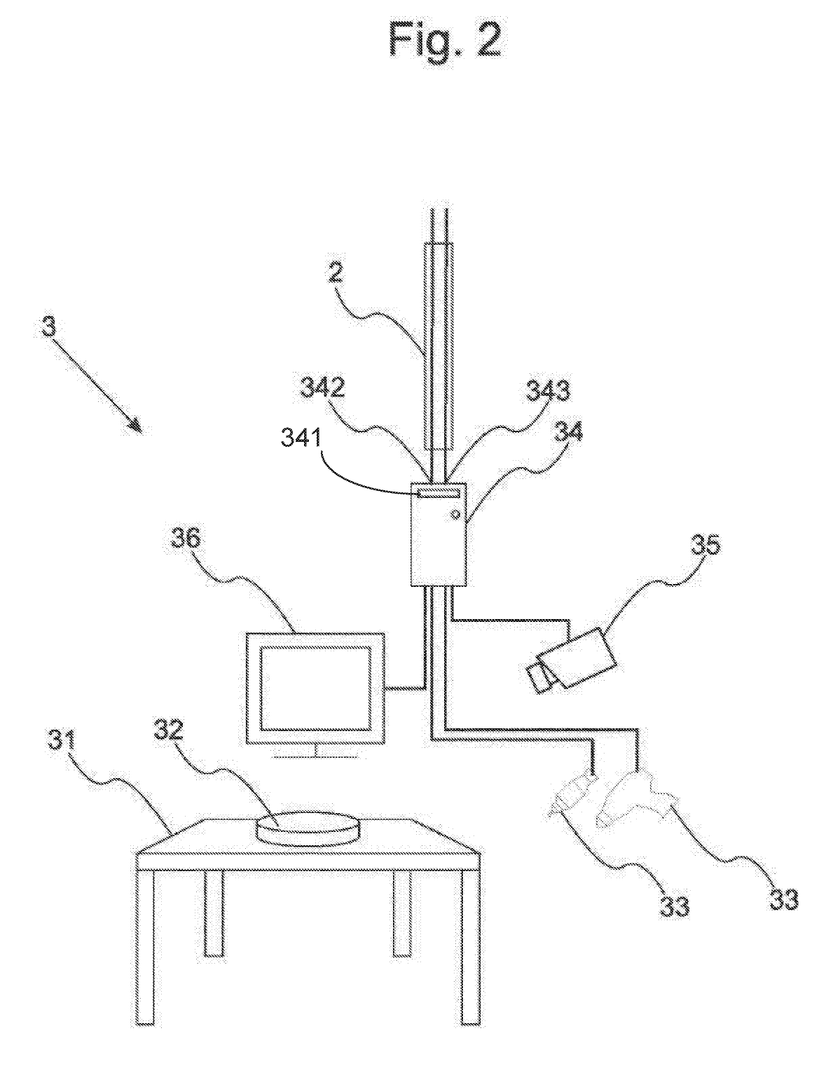

With reference to FIG. 2, a manual workstation unit 3 according to the invention is described. The manual workstation unit 3 is located in a production installation of a production installation operator and serves to carry out production operations on a component 32 which are carried out at least partially by hand. The manual workstation unit 3 comprises a work surface 31 for processing a component 32. Furthermore, the manual workstation unit 3 has a plurality of tools 33. A component may in particular be a component of metal, in particular steel, in particular a sheet-like component. A tool may be an electric tool, in particular for sheet metal processing. It may be a drill, in particular a hand drill, thread cutting device, grinding device, shearing device, nibbling device, welding device, cleaning device.

The manual workstation unit 3 has a manual workstation data-processing device 34 having a manual workstation data-processing device data store 341 which is connected via the communication connection 2 to the remote data-processing device 1. A production installation program is stored on the manual workstation data-processing device data store 341. Via a status data output interface 342, data relating to the status of the manual workstation unit are transmitted to the remote data-processing device 1. These data may be information relating to the status of the tools, the production progress of the component or sensor data of the manual workstation unit. Via a control data input interface 343, production information are transmitted from the remote data-processing device 1 to the manual workstation data-processing device 34.

The production information is stored after transmission on the manual workstation data-processing device data store 341.

The manual workstation unit 3 further has one or more sensors 35 for detecting the component 32 or processing operations on the component. The one or more of the sensor(s) 35 may, for example, be a camera which detects the work surface 31. A sensor may also be a sensor system which detects the complete work area in a three-dimensional manner. For example, but not conclusively, cameras, sonic, ultrasonic, radar sensors or laser scanners can be used as sensors. A sensor may also be provided in or on a tool 33. All these sensors may be connected in technical data terms to the manual workstation data-processing device 34. A technical data connection from a sensor in or on a tool can thus transmit operating parameters such as the operating time, the load, the ambient temperature thereof and other parameters to the manual workstation data-processing device 34. This device may prepare the data and transmit them completely or partially to the remote data-processing device 1. The operator of the remote data-processing device 1 can now itself evaluate these data and, for example, provide the tool manufacturer of the tool therewith. The technical data connection between the tool 33 and manual workstation data-processing device 34 may be carried out with a wireless connection so that it is accommodated in a state encapsulated in the tool 33 safe from contamination in the industrial environment. A sensor which can be produced in a particularly simple manner is a device for establishing the current or the consumed electrical power. With such a sensor, the manual workstation data-processing device 34 or also the remote data-processing device 1 can already establish the operating time and to some degree also the load of the tool 33. For the tool manufacturer, this information may already be very valuable. Firstly, when it receives this information together with the information as to which tool is or has been used for precisely how long and under what conditions. The anonymous information may also be useful for the tool manufacturer if it receives this information from many of their tools. It can then obtain an overview of how long its tools are generally used within a year and how it has to configure the individual components so that the tools successfully withstand these operating conditions for many, many years.

The manual workstation unit 3 has a display device 36. The display device 36 is in the embodiment a conventional data viewing device (monitor) which is connected to the manual workstation data-processing device 34. Alternatively or additionally, it may be a projection system which can project an image onto the work surface. Alternatively or additionally, it may be a portable data-processing system, such as a tablet computer, which, for example, by means of cables or by means of a radio connection, for example, WLAN, in particular in accordance with the standard IEEE-802.11, or Bluetooth, in particular in accordance with the standard IEEE 802.15.1, is connected to the manual workstation data-processing device 34. These can display information which is produced by means of the production installation program. The display device in the form of a tablet computer may also be directly connected to the remote data-processing device 1.

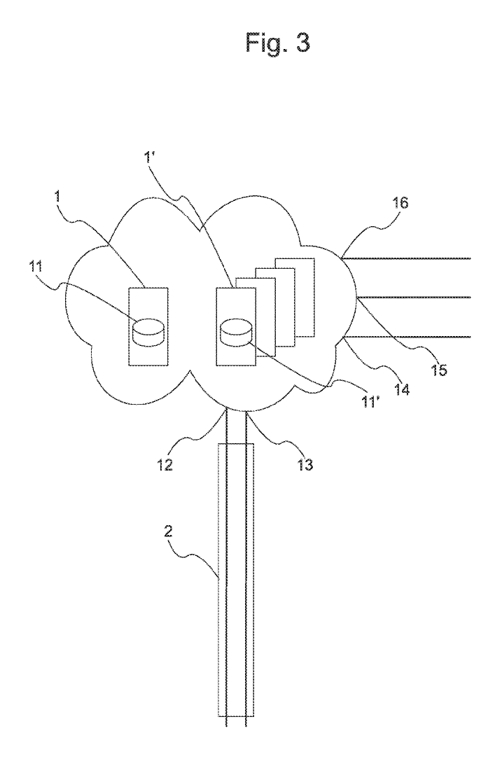

With reference to FIG. 3, the remote data-processing device 1 according to the invention will be described in detail. As already set out, the remote data-processing device 1 is accommodated in a state located remotely from the production installation of the manual workstation units 3. The remote data-processing device 1 may be located at a central location in the influence region of the production installation operator, a machine manufacturer or another external service provider.

The remote data-processing device 1 has a remote data-processing device data store 11 on which a production control program is stored. Via a status data input interface 12, data relating to the status of the manual workstation unit 3 are received via the data connection 2. Via a control data output interface 13, production information is transmitted from the remote data-processing device 1 to the manual workstation data-processing device 34.

The production installation program and production control program are configured in such a manner that via general interfaces program modules can be produced independently of each other by different providers. In this instance, there is in each case a production control program module, for example, for a specific tool 33, which can be carried out on the remote data-processing device 1 and which when implemented brings about the control operations required for this tool 33 on the remote data-processing device 1 and an associated production installation program module which can be carried out on the manual workstation data-processing device 34 and which when implemented brings about all the required control and display operations on the manual workstation data-processing device 34. The program modules may relate to individual tools and are, for example, provided by a tool manufacturer. They may also relate to individual operating steps which are intended to be or which can be carried out on the manual workstation unit 3 and can be provided by a client. Modules of the production installation program can if necessary be transmitted via the remote data-processing device 1 to the manual workstation unit 3. In this instance, the production installation program provides a user surface which displays a list of selectable production installation program modules which can be selected on the manual workstation unit 3, downloaded and stored on the manual workstation data-processing device data store 341 and can be carried out by the manual workstation data-processing device 34.

A tool database is stored on the manual workstation data-processing device data store 341. This database stores a list of tools 33 which are available on the manual workstation unit 3. Via the tool database, it is determined which modules of the manual workstation unit 3 are displayed for downloading; only modules for which a suitable tool is available on the manual workstation unit 3 are displayed for downloading in the manual workstation unit.

The remote data-processing device 1 has an order data input interface 14. Via this, data can be transmitted by a client to the remote data-processing device 1 and represent an order and contain information for producing a component 32. A client may be a company or a person which has requested that the production installation carry out production operations.

The remote data-processing device 1 has a tool provider interface 15. Via the tool provider interface 15, information relating to operating parameters of the tools 33 of the manual workstation unit 3 is transmitted to tool providers as long as they have been authorised for this. A tool provider is a company or a person which provides a tool 33 which is used at the manual workstation or is responsible for the maintenance of the operability thereof. This data transmission enables the tool provider to maintain (maintenance) or produce the operability of the tool 33 (repair).

The remote data-processing device 1 has a third party provider interface 16. A third party provider is a client, tool provider or service provider. A service provider is a provider of services, such as software, measurement data detection, analysis systems, diagnostic tools or the like. Via the third party provider interface 16, production installation program modules developed by third party providers and production control program modules are uploaded onto the remote data-processing device 1 and thus provided for the manual workstation operating system. In order to develop the production installation program modules and production control program modules, a software development kit (SDK) is provided for the third party providers for production installation program modules and production control program modules.

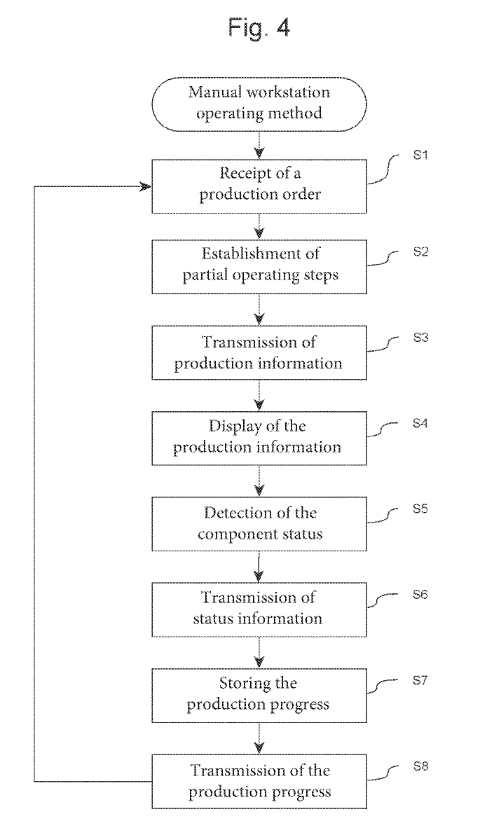

With reference to FIG. 4, a manual workstation operating method is described. In this instance, a sequence of the method steps is purely exemplary. The individual steps may also be carried out in a different sequence.

In a step S1, a production order of a client is received by the remote data-processing device 1 via the order data input interface 14.

In a step S2, from these order data, partial operating steps for producing the component 32 are established.

In a step S3, information with respect to the partial operating steps (production information) is transmitted to the manual workstation unit 3. This production information may be construction plans, production instructions, tool pre-adjustments or the like.

In a step S4, the production information relating to the partial operating steps or parts thereof is illustrated on the display device 36.

In a step S5, using the sensor 35, component status information, such as, for example, position or production progress, is established and, in a step S6, transmitted to the remote data-processing device 1. In this instance, in the embodiment using the manual workstation unit 3, the component status is established from the sensor data and the result is transmitted to the remote data-processing device 1. Alternatively or additionally, the unprocessed sensor data can be transmitted from the manual workstation unit 3 to the remote data-processing device 1 so that the remote data-processing device 1 can itself establish the component status from the unprocessed data. Alternatively or additionally, tool operating parameter information of the tool 33 which is obtained using the sensor 35 or individual tool sensors is transmitted to the remote data-processing device 1.

In a step S7, the production progress of the component 32 is stored after transmission or separate establishment in the remote data-processing device 1.

In a step S8, after detecting the production of the component 32, this is communicated to a user or another data-processing system, for example, a superordinate enterprise resource planning (EPR) system. Alternatively or additionally, the tool operating information or parts of it is/are transmitted via the tool provider interface 15 to authorized tool providers.

If a claimed manual workstation operating system is provided, operating-process-specific modules for production installation programs and production control programs can be in particular developed by third party providers independently of each other, transmitted via the third party provider interface 16 to the remote data-processing device and provided. Furthermore, if necessary, production interface program modules can be transmitted via the remote data-processing device 1 to the manual workstation unit 3. In place of or in addition to the component status data, tool data can be transmitted from the manual workstation unit 3 to the remote data-processing device 1. These tool data can be entrusted for maintenance or marketing purposes to third parties, for example, tool manufacturers.

The embodiments shown and described are not intended to be understood to be a conclusive listing but are instead of an exemplary nature for describing the invention. For the person skilled in the art, it is evident that, within the framework defined by the claims, other embodiments are conceivable.

For example, in the embodiment, the remote data-processing device is an electronic data-processing device (1). Alternatively, it may also be an assembly of electronic data-processing devices (1′). In another alternative, the remote data-processing device may be a virtual machine which is implemented on a data-processing device remote from the production installation of the manual workstation unit. The latter affords the advantage that for each production installation an isolated remote data-processing device can be provided so that an undesirable data exchange between independent production installations and a disruption of other production installations can be prevented. Alternatively, it is also possible to operate a remote data-processing device together with a plurality of production installations.

The sentential connectives “and”, “or” and “either . . . or” are used in the sense which is based on the logical conjunction, the logical adjunction (often “and/or”) or the logical contravalence. A listing of method steps serves only to illustrate a quantity of method steps and does not imply any sequence of the method steps in the sequence of the listing unless a sequence is explicitly given.

What is claimed is:

1. A manual workstation unit of a production installation of a production installation operator, comprising:
a manual workstation configured to at least partially manually carry out production operations on a component;
a manual workstation data-processing device having:
a status data output interface configured to transmit information relating to a status of the manual workstation to a remote data-processing device via a status data input interface of the remote data-processing device,
a control data input interface configured to obtain production information from the remote data-processing device via a control data output interface of the remote data-processing device,
a manual workstation data-processing device data store configured to store at least one production installation program, and
a user interface configured to output data from the manual workstation data-processing device to a user or to enable data inputs of the user to the manual workstation data-processing device; and
at least one sensor configured to detect the component and transmit component status data to the manual workstation data-processing device,
wherein the at least one production installation program is configured to control the manual workstation data-processing device to
transmit information relating to partial operating steps via the user interface to the user, and
transmit the component status data via the status data output interface to the status data input interface of the remote data-processing device such that the remote data-processing device is capable of detecting a production progress of the component.

2. The manual workstation unit of claim 1, wherein the production installation program is configured to control the manual workstation data-processing device to
transmit information relating to the status of the manual workstation to the remote data-processing device,
obtain production information from the remote data-processing device, and
output the data from the manual workstation data-processing device to the user or receive the data inputs of the user into the manual workstation data-processing device.

3. The manual workstation unit of claim 1, further comprising at least one tool having at least one operating parameter,
wherein the operating parameter is detectable by the sensor or an individual sensor of the tool and transmittable to the manual workstation data-processing device, and
wherein the at least one production installation program is configured to control the manual workstation data-processing device to transmit the operating parameter to the remote data-processing device.

4. The manual workstation unit of claim 1, wherein the at least one production installation program is configured to transmit the data inputs of the user to at least one of
the manual workstation data-processing device and
the remote data-processing device via the status data output interface of the manual workstation data-processing device and the status data input interface of the remote data-processing device.

5. The manual workstation unit of claim 1, wherein the at least one production installation program is configured to control the manual workstation data-processing device to perform operations including one of
establishing a production progress from the component status data and transmitting the production progress to the remote data-processing device and
transmitting the component status data detected by the at least one sensor to the remote data-processing device, such that the remote data-processing device is capable of establishing the production progress from the component status data.

6. The manual workstation unit of claim 1, wherein the production installation program is constructed such that, for one or more operating processes, a process production installation program module is produced or replaced independently of other process production installation program modules.

7. The manual workstation unit of claim 1, wherein the manual workstation data-processing device is configured such that production installation program modules are produced, maintained or replaced individually for different tools, operating steps or components from third party providers.

8. The manual workstation unit of claim 1, wherein the manual workstation data-processing device is configured to provide data from tools used via the remote data-processing device to third party providers.

9. The manual workstation unit according to claim 8, wherein the manual workstation data-processing device is configured to classify the provided data from the tools in accordance with different confidentiality levels.

10. A remote data-processing device comprising:
an order data input interface configured to receive customer orders for producing a component on a manual workstation unit of a production installation of a production installation operator, wherein the manual workstation unit comprises a manual workstation configured to at least partially manually carry out production operations on the component;
a status data input interface configured to receive information relating to a status of the manual workstation via a status data output interface of the manual workstation unit;
a control data output interface configured to transmit production information via the control data input interface of the manual workstation unit to the manual workstation unit; and
a remote data store configured to store at least one production control program,
wherein the at least one production control program is configured to control the remote data-processing device to:
establish, from an order input via the order data input interface, partial operating steps for producing the component,
transmit information relating to the partial operating steps via the control data output interface and a control data input interface of the manual workstation unit to the manual workstation unit,
receive component status data relating to the component via the status data output interface of the manual workstation unit and the status data input interface, and
detect a production progress of the component based on the component status data.

11. The remote data-processing device of claim 10, further comprising:
a tool database configured to store information relating to tools that are configured to be used on the manual workstation of the manual workstation unit.

12. The remote data-processing device of claim 10, further comprising:
an operating step database configured to store information relating to operating steps capable of being carried out at the manual workstation of the manual workstation unit.

13. The remote data-processing device of claim 10, wherein the production control program is constructed such that, for each operating process, a process production control program module is produced or replaced independently of other process production control program modules.

14. The remote data-processing device of claim 10, further comprising:
at least one additional interface for an additional production installation that is separated from the production installation in terms of at least one of location and organization.

15. The remote data-processing device of claim 10, further comprising:
one or more tool provider interfaces for one or more data connections from the remote data-processing device to one or more remote tool providers.

16. The remote data-processing device of claim 10, wherein the production control program is constructed such that one or more process production control program modules are provided, replaced, or maintained by one or more tool providers.

17. The remote data-processing device of claim 10, wherein the production control program is constructed such that a plurality of the process production control program modules is selectable and usable by one or more production installation operators.

18. The remote data-processing device of claim 10, further comprising:
one or more service-provider interfaces for one or more data connections from the remote data-processing device to one or more remote service providers.

19. The remote data-processing device of claim 10, wherein the production control program is configured to control the remote data-processing device, such that data of different third party providers are separated from each other in accordance with specifications for data provision of respective data producers, and such that each of the third party providers only gains access to respective data released by a data producer for the third party provider.

20. A manual workstation operating method comprising:
receiving, from a remote data-processing device, information relating to partial operating steps for producing a component at a manual workstation unit, wherein the partial operation steps are established from order data by the remote data-processing device;
displaying the information with respect to the partial operating steps by a user interface of the manual workstation unit;
detecting component status data of the component by a sensor of the manual workstation unit; and
transmitting at least one of the component status data and a production progress of the component based on the component status data to the remote data-processing device, such that the remote data-processing device is capable of detecting the production progress of the component and communicating completion of the component to a user or a data-processing system.
